(19) United States
(12) Patent Application Publication
(10) Pub. No.: US 2006/0067319 A1
(43) Pub. Date: Mar. 30, 2006

(54) Communication system and master apparatus

(75) Inventor: Katsuya Sasahara, Izu-shi (JP)

Correspondence Address: FOLEY AND LARDNER LLP;SUITE 500, 3000 K STREET NW, WASHINGTON, DC, 20007, US

(73) Assignee: TOSHIBA TEC KABUSHIKI KAISHA

(21) Appl. No.: 11/008,130

(22) Filed: Dec. 10, 2004

(30) Foreign Application Priority Data
Sep. 28, 2004 (JP) 2004-281782

(51) Int. Cl. H04L 12/28

(52) U.S. Cl. 370/392; 370/474; 370/476

(57) ABSTRACT

In a slave station, the reception terminal and the transmission terminal can be connected to the reception terminal and the transmission terminal of the extension connector of a master station. Two-byte data is transmitted and received between the master station and the slave station as one packet. The master station specifies a device ID, an address, and read/write in a first byte and stores the data in a second byte to transmit the data. The slave station performs a read process or a write process when the slave station determines that the device ID set in the first byte of reception data is identical to the device ID of the slave station.

### CROSS-REFERENCE TO RELATED APPLICATIONS

This application is based upon and claims the benefit of priority from prior Japanese Patent Application No. 2004-281782, filed Sep. 28, 2004, the entire contents of which are incorporated herein by reference.

### BACKGROUND OF THE INVENTION

1. Field of the Invention

The present invention relates to a communication system in which a plurality of slave stations can be connected to a master station.

2. Description of the Related Art

In the communication system in which the plurality of slave stations is connected to the master station, the communication system in which one of communication ASICI 12 and ASICI 13 is used for data transmission between the master station and a normal slave station 2 and the other is used for the data transmission between the master station and an inverted type slave station 3 is well known (Jpn. Pat. Appln. KOKAI Publication No. 10-313328).

However, in Jpn. Pat. Appln. KOKAI Publication No. 10-313328, since two channels of ASICI 12 and ASICI 13 are used, there is a problem that the number of occupied channels is large.

### BRIEF SUMMARY OF THE INVENTION

An object of the invention is to provide the communication system and the master apparatus, in which the plurality of slave station can be connected by using one serial interface of the master station.

According to an aspect of the invention, there is provided a communication system comprising: a master apparatus having; a plurality of extension connectors, each extension connector having a transmission terminal and a reception terminal, a serial port having transmission lines and reception lines, transmission units which are connected between the transmission line and the transmission terminal of the each extension connector, respectively and reception units which are connected between the reception line and the reception terminal of the each extension connector respectively, the each reception unit being wired-connected to the reception line; and a slave apparatus whose reception terminal and transmission terminal can be connected to the transmission terminal and the reception terminal of the extension connector of the master apparatus respectively, wherein the master apparatus has a first communication control unit configured to transmit two-byte data, in which a device ID, an address, specification of read/write are stored in a first byte and data is stored in a second byte, in one-packet form, and the slave apparatus has a second communication unit configured to perform a read process or a write process when the slave apparatus determines that the device ID set in the first byte of reception data is identical to the device ID of the slave apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram for explaining a communication system according to an embodiment of the invention;

FIG. 2A shows a data format of a first byte of data transmitted in the communication system of the embodiment;

FIG. 2B shows a data format of a second byte of the data transmitted in the communication system of the embodiment;

FIG. 2C shows a data format of the first byte of data received in the communication system of the embodiment;

FIG. 2D shows a data format of the second byte of the data received in the communication system of the embodiment;

FIG. 3 is a flowchart showing operation of a master station according to the embodiment;

FIG. 4 is a flowchart showing operation of a slave station according to the embodiment;

FIG. 5 shows an image forming apparatus on which the communication system according to the embodiment is mounted; and

FIG. 6 is a diagram for explaining an installation position an extension connector according to the embodiment.

### DETAILED DESCRIPTION OF THE INVENTION

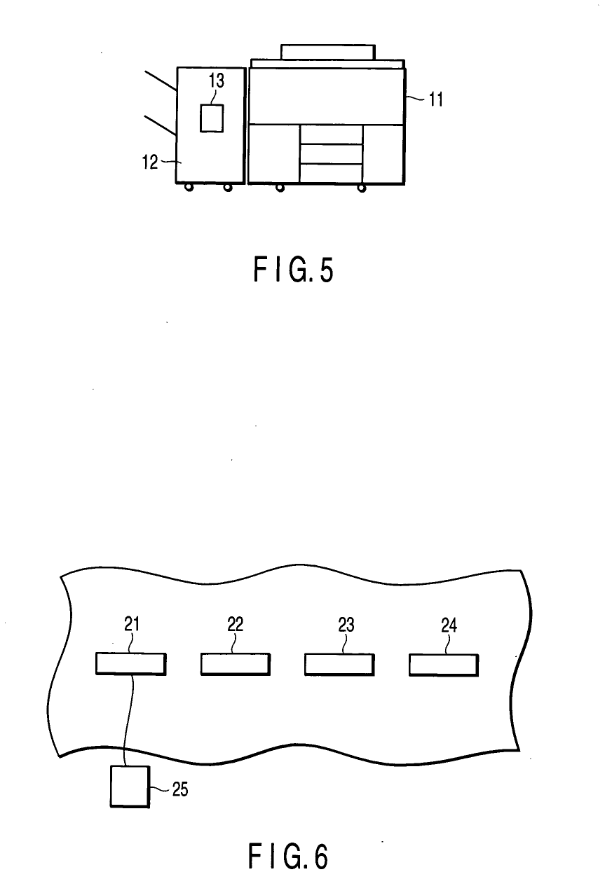

Referring to the accompanying drawings, an embodiment of the invention will be described below. In FIG. 5, the reference numeral 11 represents an MFP main body, the reference numeral 12 represents a finisher which performs a post-process to paper in which an image is formed in the MFP main body, and the reference numeral 13 represents a CPU of the finisher 12. Hereinafter the finisher 12 is referred to as the master station. For example, as shown in FIG. 6, four extension connectors 21 to 24 are provided in one side surface of the master station 12. A slave station 25 as an option device can be connected to each of the four extension connectors 21 to 24 as necessary. The option device includes a saddle switcher, a puncher, a Z-holder, and an inserter. Each option device includes a start-stop synchronous serial interface.

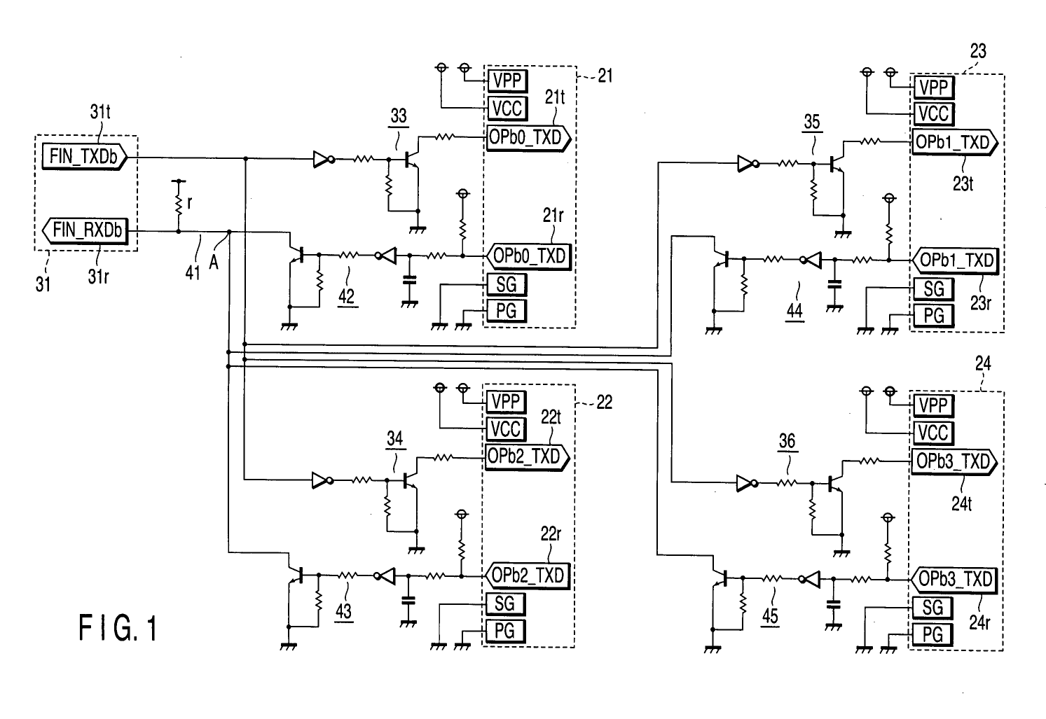

Then, referring to FIG. 1, a configuration of a main part of the master station 12 will be described. The master station 12 includes the extension connectors 21 to 24 of FIG. 5.

The reference numeral 31 represents a serial port of the CPU 13. A transmission terminal 31t of the serial port 31 is connected to a transmission terminal 21t of the extension connector 21 through a transmission line 32 and a transmission circuit 33. The transmission terminal 31t is also connected to a transmission terminal 22t of the extension connector 22 through a transmission circuit 34. The transmission terminal 31t is also connected to a transmission terminal 23t of the extension connector 23 through a transmission circuit 35. The transmission terminal 31t is also connected to a transmission terminal 24t of the extension connector 24 through a transmission circuit 36.

A reception terminal 31r of the serial port 31 is connected to a reception terminal 21r of the extension connector 21 through a reception line 41 and a reception circuit 42. The reception terminal 31r is also connected to a reception terminal 22r of the extension connector 22 through a reception circuit 43. The reception terminal 31r is also connected to a reception terminal 23r of the extension connector 23 through a reception circuit 44. The reception terminal 31r is also connected to a reception terminal 24r of the extension connector 24 through a reception circuit 45. That is, each of the reception circuits 41 to 44 is wired-connected to the reception line 41 connected to the reception terminal 31r of the serial port 31. The reception line 41 located between a wired-connected position A and the reception terminal 31r is connected to a power supply through a pull-up resistor r.

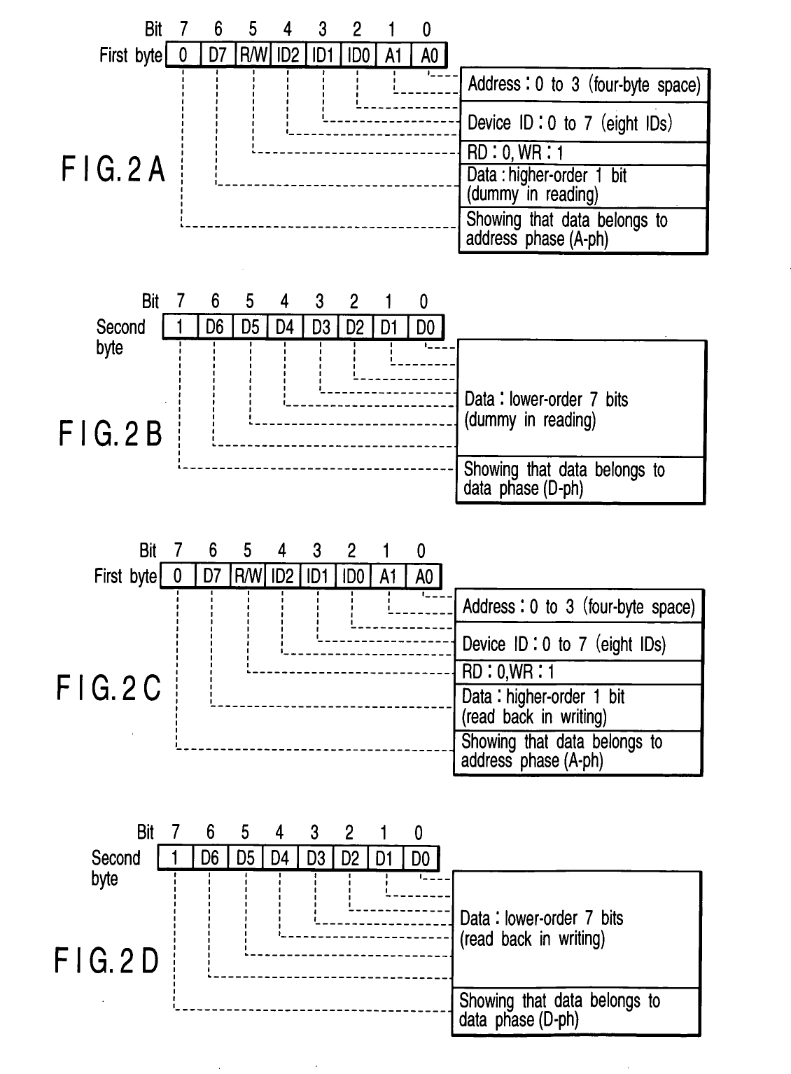

Then, referring to FIG. 2, a data format of a command which is transmitted and received between the master station 12 and the slave station 25 will be described. As described above, the two-byte data is transmitted and received in one-packet form between the master station 12 and the slave station 25.

A first byte data format in the two-byte data transmitted from the master station 12 to the slave station 25 will first be described referring to FIG. 2A. As shown in FIG. 2A, when the leftmost bit (bit 7) is “0”, it is meant that the data belongs to the first byte. That is, it is shown that the data belongs to an address phase. Bits 0 and 1 show the address, bits 2 to 4 shows a device ID, and bit 5 shows whether read is specified or write is specified. When the bit 5 is “0”, the read is specified. When the bit 5 is “1”, the write is specified. The leftmost bit (D7) of the data is set in bit 6.

A second byte data format in the two-byte data will first be described referring to FIG. 2B. “1” is set in the bit 7. “1” of the bit 7 means that the data is stored in the second byte. That is, it is meant that the data belongs to a data phase.

Data D0 to data D6 are stored in the bit 0 to the bit 6 (only in writing). That is, when the write data (D0 to D7) is transmitted from the master station 12 to the slave station 25, only the data D7 is stored in the bit 6 of the first byte, and the data D0 to the data D6 are stored in the second byte.

Then, the data format of the two-byte data transmitted from the slave station 25 to the master station 12 will be described referring to FIGS. 2C and 2D.

At first, “0” is set in the leftmost bit 7 of the first byte data. That is, “0” in the bit 7 shows that the data is belongs to the address phase.

The bits 0 and 1 show the address, bits 2 to 4 shows the device ID, and bit 5 shows whether read is specified or write is specified.

When the bit 5 is “0”, the read is specified. When the bit 5 is “1”, the write is specified. The data (D7) is set in bit 6.

The second byte data format in the two-byte data will be described referring to FIG. 2D. “1” is set in the bit 7. “1” of the bit 7 means that the data is stored in the second byte. That is, it is meant that the data belongs to a data phase.

The data D0 to the data D6 are stored in the bit 0 to the bit 6 (read data in reading and read back in writing). That is, when the read data (D0 to D7) is transmitted from the slave station 25 to the master station 12, only the data D7 is stored in the bit 6 of the first byte, and the data D0 to the data D6 are stored in the second byte.

An embodiment of the invention having the above-described configuration will be described below. The serial interface of the slave station 25 is connected to a disengaged connector in the extension connectors 21 to 24 of the master station 12. At this point, the device ID of the slave station is stored in the slave station.

The master station 12 transmits the two-byte data shown in FIGS. 2A and 2B through the transmission terminal 31t of the serial port 31, and the two-byte data is outputted to the transmission terminals 21t to 24t of the extension connectors 21 to 24 through the transmission circuits 33 to 36. Therefore, the two-byte data is transmitted to the slave station 25 when the serial interface of the slave station 25 is connected to one of the extension connectors 21 to 24.

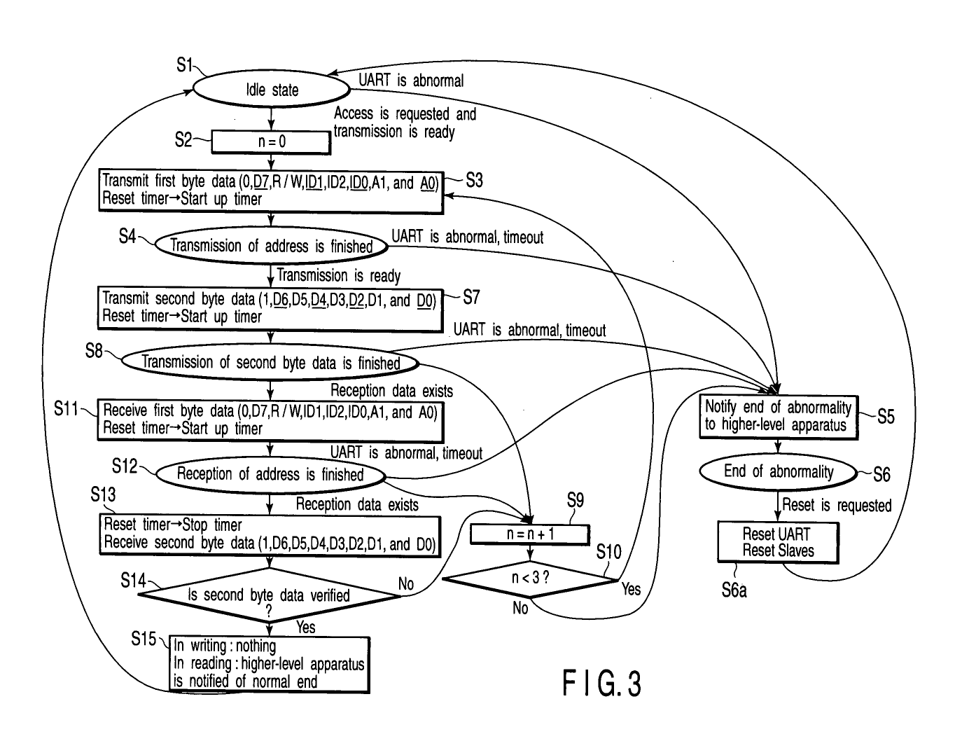

The process of the master station 12 will be described referring to a flowchart (first communication control unit) of FIG. 3. The master station 12 is in a standby state (Step S1). The master station 12 sets a counter n which counts the number of transmission errors to “0” (Step S2).

The master station 12 sets the address, the device ID, and the specification of read/write in the first byte data. The master station 12 resets and starts up a timer while outputting the first byte data to the transmission terminals 21t to 24t of the extension connector 21 to 24 (Step S3).

The master station 12 determines whether the transmission of the first byte data is finished or not (Step S4). When a timeout occurs in the timer started up in Step S3, a higher-level apparatus is notified of abnormality (step S5). Then, the abnormality is ended (Step S6). After UART is reset and the slaves are reset (Step S6a), the flow returns to the idle state (Step S1).

When the transmission of the first byte data is finished, the master station 12 writes the necessary data in the second byte data shown in FIG. 2B to transmit the second byte data, and the timer is started up after the timer is reset (Step S7).

The master station 12 determines whether the transmission of the second byte data is finished or not (Step S8). When the timeout occurs in the timer in the decision of Step S8, the timer is set to n=n+1 (Step S9). The master station 12 determines whether n is smaller than 3 or not (Step S10). When the number n of errors becomes 3 (“NO” in the decision of Step S10), the error processes from Step S5 are performed.

When n is smaller than 3 (“YES” in the decision of Step S10), the master station 12 retries the transmission of the first byte data.

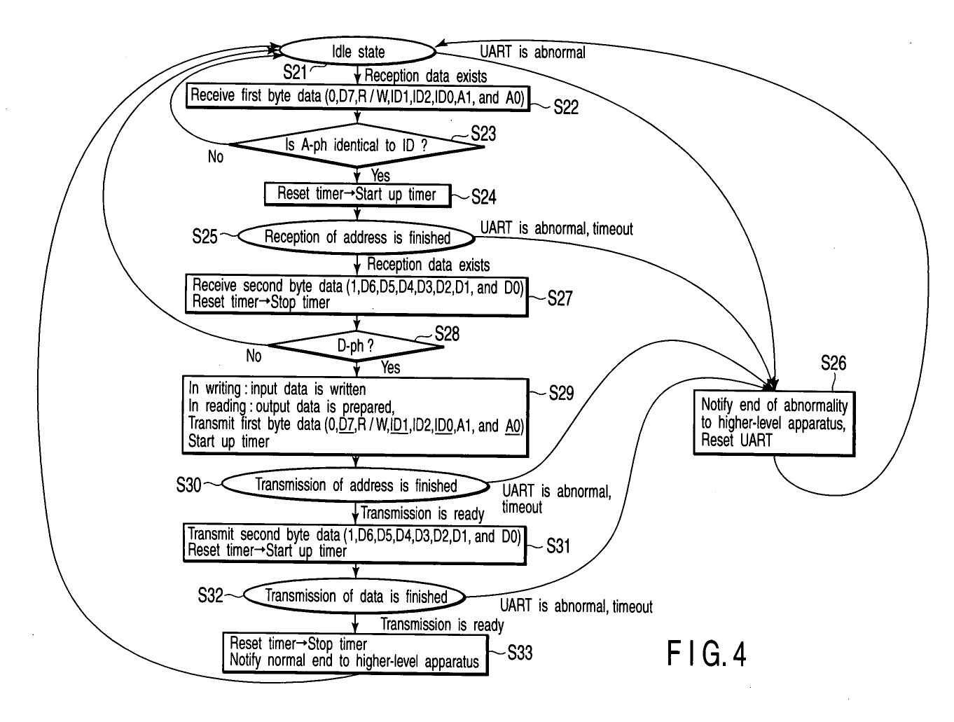

When the transmission of the second byte data is finished in the decision of Step S8, the flow is transferred to reception processes from Step S11. The reception processes from Step S11 will be described after the reception processes in the slave station 25 of FIG. 4.

The process in the slave station 25 will be described below referring to a flowchart (second communication control unit) of FIG. 4. At first the slave station 25 is in the idle state (Step S21). The slave station 25 receives first byte data through the transmission terminals 21t to 24t of the extension connectors (Step S22). The slave station 25 determines whether the leftmost bit in the first byte data is “0” and the device ID stored in the first byte data transmitted from the master station 12 is identical to the device ID of the slave station 25 (Step S23). If “YES” in step S23, the timer is reset and started up (Step S24).

The slave station 25 determines whether the address is received (Step S25). When the timeout occurs in the timer before the address is received, the error process is performed. The higher-level apparatus is notified of the end of the abnormality (step S26).

When the slave station 25 determines that the address is received in Step S25, the slave station 25 receives the second byte data (Step S27). Then, the timer is reset and stopped.

The slave station 25 determines whether the left-most bit in the received second byte data is “1” (data phase) (Step S28).

When the bit 5 in the received first byte data is “1” (write), the slave station 25 performs the process of writing D0 to D7 in the addresses A1 and A0. When the bit 5 in the received first byte data is “0” (read), the slave station 25 performs the process of reading the data in the addresses A1 and A0 to set the data to two-byte data transmitted back to the master station 12. Then, the slave station 25 transmits the first byte data to the master station 12. The timer is started up. (Step S29).

The slave station 25 determines whether the transmission of the first byte data is finished (Step S30). When the timeout occurs in the timer in Step S30, the flow proceeds to Step S26 to perform the error process.

When the slave station 25 determines that the transmission of the first byte data is finished, the slave station 25 transmits the second byte data (Step S31). That is, in the case of the read process, the read data is set in D0 to D7. In the case of the write process, the written data is read to set the data in D0 to D7. Then, the timer is reset.

The slave station 25 determines whether the transmission of the second byte data is finished (Step S32). When the timeout occurs in the timer in Step S32, the error process in Step S26 is performed.

When the slave station 25 determines that the transmission of the second byte data is finished in Step S32, the timer is reset and the higher-level apparatus is notified of the normal end (Step S33). Then, the flow returns to the idle state.

The reception processes from Step S11 of the flowchart shown in FIG. 3 in the master station 12 will be described. The master station 12 receives the data transmitted from the slave station 25 through the reception circuits 42 to 45. The master station 12 receives the first byte data, and the timer is reset and started up (Step S11). The master station 12 determines whether the addresses A1 and A0 of first byte data are received (Step S12). When the master station 12 determines that the timeout occurs in the timer, the processes from Step S9 are performed.

When the master station 12 determines that the addresses A1 and A0 are received in Step S12, the timer is reset, and the master station 12 receives the second byte data (Step S13).

The master station 12 verifies whether the second byte data is correct (Step S14). When the master station 12 determines that the second byte data is not correct (“NO” in the decision of Step S14), the processes from Step S9 are performed.

When the master station 12 determines that the second byte data is correct (“YES” in the decision of Step S14), the process of transferring the read input data within the master station 12 is performed in reading, and the higher-level apparatus is notified of the normal end (Step S15).

Thus, a series of processes is ended.

That is, when the slave station 25 is connected to the extension connectors 21 to 24 of the master station 12, the slave station 25 can be connected to the disengaged extension connector. Usually, the slave station 25 includes the start-stop synchronous serial interface, so that the already-existing interface can be used to achieve cost reduction form the viewpoint of hardware.

Further, since the extension connectors 21 to 24 of the master station 12 have four pairs of each of the transmission circuits 33 to 36 and each of the reception circuits 42 to 45, high-speed and stable communication can be secured with no influence of cable impedance of the slave station 25.

In the embodiment, the finisher 12 is set to the master station and the option device connected to the finisher 12 is set to the slave station 25. However, the invention is not limited to the finisher, but the invention can be applied to various types of the electronic equipment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication system comprising:
a master apparatus having;
a plurality of extension connectors, each extension connector having a transmission terminal and a reception terminal,
a serial port having transmission lines and reception lines,
transmission units which are connected between the transmission line and the transmission terminal of said each extension connector, respectively and
reception units which are connected between the reception line and the reception terminal of said each extension connector respectively, said each reception unit being wired-connected to the reception line; and
a slave apparatus whose reception terminal and transmission terminal can be connected to the transmission terminal and the reception terminal of the extension connector of the master apparatus respectively,
wherein the master apparatus has a first communication control unit configured to transmit two-byte data, in which a device ID, an address, specification of read/write are stored in a first byte and data is stored in a second byte, in one-packet form, and
the slave apparatus has a second communication unit configured to perform a read process or a write process when the slave apparatus determines that the device ID set in the first byte of reception data is identical to the device ID of the slave apparatus.

2. A communication system according to claim 1,
wherein a bit indicating that the data belong to the first byte or the second byte is stored in the leftmost bit of the two-byte data transmitted from the master apparatus and the slave apparatus.

3. A communication system according to claim 1,
wherein the slave apparatus determines the first byte data received from the master apparatus by the leftmost bit., and the slave apparatus starts to read the next reception data when the device ID set in the first byte is not identical to the device ID of the slave apparatus.

4. A communication system according to claim 1,
wherein the master apparatus is a finisher which performs post-process of an image forming apparatus.

5. A communication system according to claim 1,
wherein the slave apparatus is a saddle switcher, a puncher, a Z-holder, and an inserter.

6. A master apparatus comprising:
a plurality of extension connectors, each extension connector having a transmission terminal and a reception terminal;
a serial port having transmission lines and reception lines;
transmission units which are connected between the transmission line and the transmission terminal of said each extension connector respectively;
reception units which are connected between the reception line and the reception terminal of said each extension connector respectively, said each reception unit being wired-connected to the reception line;
a transmission control unit configured to transmit two-byte data, in which a device ID, an address, specification of read/write are stored in a first byte and data is stored in a second byte, in one-packet form through said each transmission units; and
a reception control unit configured to receive the two-byte data through said each reception unit.

7. A master apparatus according to claim 6,
wherein a bit indicating that the data belong to the first byte or the second byte is stored in the leftmost bit of the two-byte data transmitted through the transmission unit.
